(19) United States
(12) Patent Application Publication
(10) Pub. No.: US 2023/0173954 A1
(43) Pub. Date: Jun. 8, 2023

(54) SEAT STRUCTURE FOR VEHICLE

(71) Applicants: Hyundai Motor Company, Seoul (KR); Kia Corporation, Seoul (KR); DAS CO., LTD, Gyeongju (KR)

(72) Inventors: Dong Woo Jeong, Gwacheon (KR); Sang Ho Kim, Incheon (KR); Seon Chae Na, Yongin (KR); Do Wan Kim, Changwon (KR); Jae Hwan Lee, Suwon (KR)

(21) Appl. No.: 17/978,001

(22) Filed: Oct. 31, 2022

(30) Foreign Application Priority Data
Dec. 6, 2021 (KR) 10-2021-0172878

(51) Int. Cl. B60N 2/14; B60N 2/68

(52) U.S. Cl. CPC B60N 2/14; B60N 2/68

(57) ABSTRACT

The present disclosure relates to a seat structure for a vehicle, in which a swivel upper plate module is configured by integrating and modularizing a swivel upper plate part, a swivel reinforcing member part, and set bracket parts, the swivel upper plate module is coupled to a seat cushion frame, and left, right, and rear sides of the swivel upper plate module are positioned inward from left, right, and rear sides of a seat bracket coupled to a seat, such that a design of a lower side of the seat may be slim.

### CROSS-REFERENCE TO RELATED APPLICATION

The present application is based on and claims under 35 U.S.C. § 119(a) priority to Korean Patent Application No. 10-2021-0172878, filed Dec. 6, 2021, the entire contents of which is incorporated herein for all purposes by this reference.

### BACKGROUND

### Technical Field

Embodiments of the present disclosure relate to a seat structure for a vehicle, and more particularly, to a technology related to a seat structure for a vehicle, in which a swivel upper plate module, into which a swivel upper plate, a swivel reinforcing member, and a set bracket are modularized and integrated, is coupled to a seat frame.

### Description of the Related Art

A vehicle is equipped with seats in which passengers, who get in the vehicle, may be seated.

The seat for a vehicle typically includes a seat cushion configured to support a passenger's lower body, a seatback configured to support the passenger's upper body, and a headrest configured to support the passenger's heat.

The seat is coupled to a seat rail and installed to be movable forward and rearward along the seat rail. The seat includes a swivel device so that the seat may be rotated, as necessary.

Meanwhile, the seat equipped with the swivel device includes a swivel upper plate coupled to a seat cushion frame, a swivel reinforcing member configured to reinforce strength of the swivel device, and a set bracket to which a rotary link is coupled to adjust a height of the seat. However, there is a problem in that because the swivel upper plate, the swivel reinforcing member, and the set bracket are configured as separate components, the number of components is large, a large amount of cost is required, and a weight is heavy.

A total of two set brackets may be provided one for each of the left and right sides of the seat. Alternatively, a total of four set brackets may be provided one for each of the left front and right front sides and one for each of the left rear and right rear sides.

### SUMMARY

In one aspect, a seat structure for a vehicle is provided, the seat structure comprising: a) a swivel upper plate module comprising: i) a swivel plate part; ii) a swivel reinforcing member part; and iii) set bracket parts to which a rotary link is coupled to adjust a height of a seat are modularized to be integrated; and b) a seat frame to which the swivel upper plate module is fixedly coupled. Preferably, the swivel upper plate part is configured to constitute a swivel device. Preferably, the swivel reinforcing member part is configured to reinforce strength of the swivel upper plate part

In a further aspect, a seat structure is provided for a vehicle, the seat structure including: a swivel upper plate module in which a swivel upper plate part configured to constitute a swivel device, a swivel reinforcing member part configured to reinforce strength of the swivel upper plate part, and set bracket parts to which a rotary link is coupled to adjust a height of a seat are modularized to be integrated; and a seat frame to which the swivel upper plate module is fixedly coupled.

The swivel upper plate part may be fixedly coupled to a seat cushion frame.

The set bracket parts may be configured to extend in a forward/rearward direction and be connected to left and right sides of the swivel upper plate part, and the swivel reinforcing member part may be connected to a front surface of the swivel upper plate part and have two opposite left and right ends connected to the set bracket parts.

The swivel upper plate module may further include a rear reinforcing part protruding upward from a rear surface of the swivel upper plate part.

The swivel upper plate module may be made of nonferrous metal to reduce weight thereof.

The swivel upper plate module may be made of any one nonferrous metal among aluminum alloys or zinc alloys to reduce weight thereof.

Left and right sides of the swivel upper plate module may be positioned inward from left and right sides of a seat bracket coupled to the seat to cover a lower side of the seat, such that a design of the lower side of the seat is slim, and left and right spaces at the slim lower side of the seat ensure foot spaces for passengers seated in rear seats.

A rear side of the swivel upper plate module may be positioned inward from a rear side of a seat bracket coupled to the seat to cover a lower side of the seat, such that a design of the lower side of the seat is slim, and a rear space at the slim lower side of the seat may ensure a foot space for a passenger seated in a rear seat.

Further, embodiments of the present disclosure provide a seat structure for a vehicle, the seat structure including: a swivel upper plate module in which a swivel upper plate part configured to constitute a swivel device and set bracket parts to which a rotary link is coupled to adjust a height of a seat are modularized to be integrated; and a seat frame to which the swivel upper plate module is fixedly coupled.

The swivel upper plate module may further include a swivel reinforcing member part connected to a front surface of the swivel upper plate part and having two opposite left and right ends connected to the set bracket parts, the swivel upper plate module being configured to reinforce strength of the swivel upper plate part.

The swivel upper plate module may further include a rear reinforcing part protruding upward from a rear surface of the swivel upper plate part.

In the seat structure for a vehicle according to embodiments of the present disclosure, the swivel upper plate module is configured by integrating and modularizing the swivel upper plate part, the swivel reinforcing member part, and the set bracket parts, and the swivel upper plate module is coupled to the seat cushion frame. Therefore, it is possible to reduce the number of components, costs, and weight in comparison with the structure in the related art in which the swivel upper plate, the swivel reinforcing member, and the set bracket are configured as separate components.

In addition, in the seat structure according to embodiments of the present disclosure, the modularized structure in which the set bracket parts are integrated with the swivel upper plate module is implemented. Therefore, the left and right sides of the swivel upper plate module are positioned inward from the left and right sides of the seat bracket coupled to the seat to cover a lower side of the seat. Therefore, the design of the lower side of the seat may be slim, and the left and right spaces of the slim lower side of the seat may ensure foot spaces for the passengers seated in the rear seats, thereby improving ride quality of the passengers.

In addition, in the seat structure according to embodiments of the present disclosure, the modularization structure in which the set bracket parts are integrated with the swivel upper plate module is implemented. Therefore, the rear side of the swivel upper plate module is positioned inward from the rear side of the seat bracket coupled to the seat to cover the lower side of the seat. Therefore, the design of the lower side of the seat may be slim, a rear space of the slim lower side of the seat may ensure a foot space for the passenger seated in the rear seat, thereby improving ride quality of the passenger.

As discussed, the system suitably includes use of a controller or processer.

In another embodiment, vehicles are provided that comprise an apparatus as disclosed herein.

### BRIEF DESCRIPTION OF THE DRAWINGS

FIG. 1 is a view for explaining a seat structure for a vehicle according to the present disclosure.

FIG. 2 is an exploded view of FIG. 1.

FIG. 3 is a perspective view of a swivel upper plate module according to the present disclosure.

FIGS. 4 to 5 are views illustrating front and lateral sides of the seat structure for a vehicle according to the present disclosure.

### DETAILED DESCRIPTION

Specific structural or functional descriptions of embodiments of the present disclosure disclosed in this specification or application are exemplified only for the purpose of explaining the embodiments according to the present disclosure, the embodiments according to the present disclosure may be carried out in various forms, and it should not be interpreted that the present disclosure is limited to the embodiments described in this specification or application.

Because the embodiments according to the present disclosure may be variously changed and may have various forms, specific embodiments will be illustrated in the drawings and described in detail in the present specification or application. However, the descriptions of the specific embodiments are not intended to limit embodiments according to the concept of the present disclosure to the specific embodiments, but it should be understood that the present disclosure covers all modifications, equivalents and alternatives falling within the spirit and technical scope of the present disclosure.

The terms such as “first” and/or “second” may be used to describe various constituent elements, but these constituent elements should not be limited by these terms. These terms are used only for the purpose of distinguishing one constituent element from other constituent elements. For example, without departing from the scope according to the concept of the present disclosure, the first constituent element may be referred to as the second constituent element, and similarly, the second constituent element may also be referred to as the first constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements. Other expressions, that is, “between” and “just between” or “adjacent to” and “directly adjacent to”, for explaining a relationship between constituent elements, should be interpreted in a similar manner.

The terms used in the present specification are used only for the purpose of describing particular embodiments and are not intended to limit the present disclosure. Singular expressions include plural expressions unless clearly described as different meanings in the context. In the present specification, it should be understood the terms “comprises,” “comprising,” “includes,” “including,” “containing,” “has,” “having” or other variations thereof are inclusive and therefore specify the presence of stated features, numbers, steps, operations, elements, components, or combinations thereof, but do not preclude the presence or addition of one or more other features, numbers, steps, operations, elements, components, or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless otherwise defined, all terms used herein, including technical or scientific terms, have the same meaning as commonly understood by those skilled in the art to which the present disclosure pertains. The terms such as those defined in commonly used dictionaries should be interpreted as having meanings consistent with meanings in the context of related technologies and should not be interpreted as ideal or excessively formal meanings unless explicitly defined in the present specification.

A control unit (controller) according to an exemplary embodiment of the present disclosure may be implemented by a non-volatile memory (not illustrated) configured to algorithm for controlling operations of various constituent elements in a vehicle or store data related to software commands for executing the algorithm, and by a processor (not illustrated) configured to perform the following operations by using the data stored in the corresponding memory. In this case, the memory and the processor may be implemented as separate chips. Alternatively, the memory and the processor may be implemented as a single chip in which the memory and the processor are integrated. The processor may be configured in the form of one or more processors.

Hereinafter, a seat structure for a vehicle according to an exemplary embodiment of the present disclosure will be described with reference to the accompanying drawings.

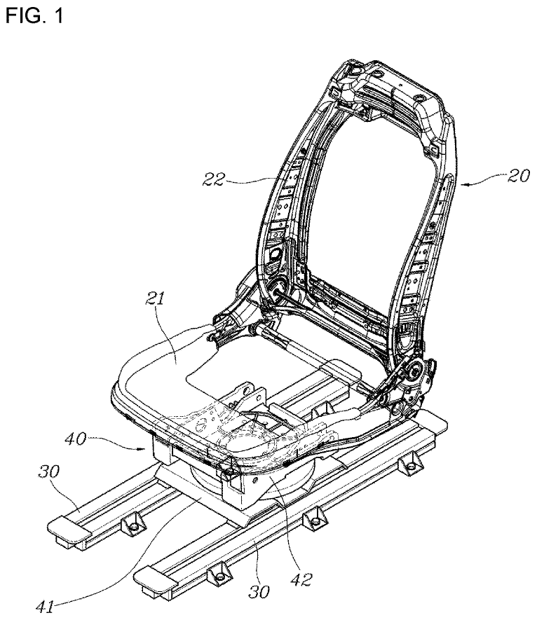

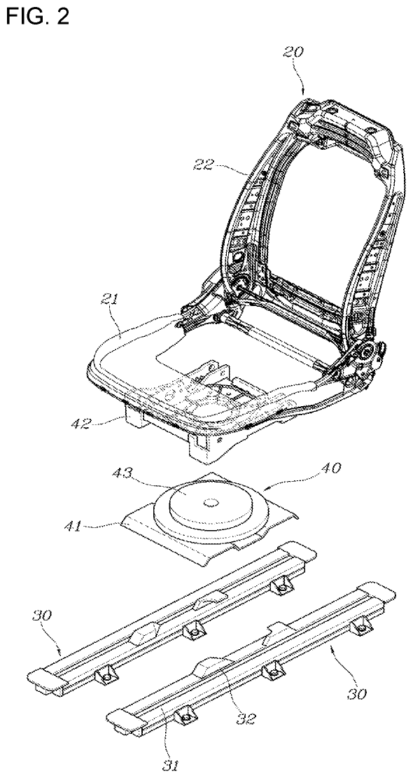

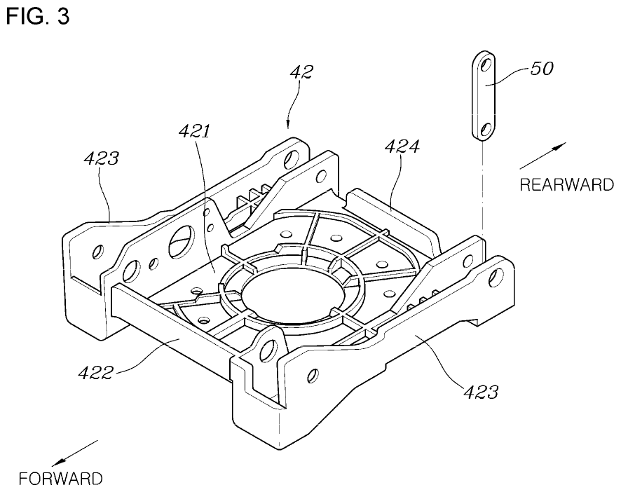

As illustrated in FIGS. 1 to 5, a seat 10 for a vehicle may include a seat cushion 11 configured to support a passenger's lower body, a seatback 12 configured to support the passenger's upper body, and a headrest 13 configured to support the passenger's head.

The seat 10 may include a seat frame 20 that defines a framework. A foam pad and a seat cover made of leather may be coupled to and cover the seat frame 20.

The seat frame 20 may include a seat cushion frame 21 configured to define a framework of the seat cushion 11, and a seatback frame 22 configured to define a framework of the seatback 12.

The seat 10 may be coupled to seat rails 30 and installed to be movable forward and rearward along the seat rails 30.

The seat rail 30 may include a stationary rail 31 extending forward and rearward and fixedly installed on a floor surface of an interior of the vehicle, and a movable rail 32 configured to move forward and rearward along the stationary rail 31. The seat cushion frame 21 may be connected to the movable rails 32, such that the seat 10 may move forward and rearward along the seat rails 30.

The seat 10 for a vehicle may have a structure installed to be rotatable as necessary. The seat 10 may include a swivel device 40 to implement the rotational structure of the seat 10.

The swivel device 40 may include a swivel lower plate 41 fixedly coupled to the movable rails 32 of the seat rails 30, a swivel upper plate module 42 according to embodiments of the present disclosure, and a swivel operation unit 43 disposed between the swivel lower plate 41 and the swivel upper plate module 42 and configured to operate to rotate the swivel upper plate module 42 relative to the swivel lower plate 41.

Because the configuration of the swivel operation unit 43 is based on a general structure publicly known from patent documents, a detailed description thereof will be omitted.

The seat structure for a vehicle according to the embodiment of the present disclosure may include the swivel upper plate module 42 configured to constitute the swivel device 40, and the seat frame 20 to which the swivel upper plate module 42 is fixedly coupled.

The swivel upper plate module 42 according to embodiments of the present disclosure may include a swivel upper plate part 421 fixedly coupled to the seat cushion frame 21, a swivel reinforcing member part 422 configured to reinforce strength of the swivel upper plate part 421 and set bracket parts 423 coupled to a rotary link 50 to adjust a height of the seat 10. The swivel upper plate part 421, the swivel reinforcing member part 422, and the set bracket part 423 may be modularized to be integrated.

That is, the swivel upper plate module 42 according to embodiments of the present disclosure may be manufactured as a single component. In this case, the swivel upper plate part 421, the swivel reinforcing member part 422, and the set bracket part 423 are modularized to be integrated.

The swivel upper plate part 421 of the swivel upper plate module 42 may be fixedly coupled to the seat cushion frame 21 and connected to the swivel operation unit 43 that constitutes the swivel device 40.

The set bracket parts 423 may be respectively connected to the left and right sides of the swivel upper plate part 421 and extend in a forward/rearward direction, and the rotary link 50 may be coupled to the set bracket parts 423 to adjust a height of the seat 10.

The swivel reinforcing member part 422 may be connected to a front surface of the swivel upper plate part 421. Two opposite left and right ends of the swivel reinforcing member part 422 may be connected to the set bracket parts 423, thereby improving strength of the swivel upper plate part 421.

In the embodiment according to the present disclosure, the swivel upper plate module 42, in which the swivel upper plate part 421, the swivel reinforcing member part 422, and the set bracket parts 423 may be modularized to be integrated, may reduce the number of components, costs, and weight in comparison with a structure in the related art in which a swivel upper plate, a swivel reinforcing member, and a set bracket are configured as separate components.

The swivel upper plate module 42 according to embodiments of the present disclosure may further include a rear reinforcing part 424 protruding upward from a rear surface of the swivel upper plate part 421. The rear reinforcing part 424 may further increase strength of the swivel upper plate part 421.

The swivel upper plate module 42 according to embodiments of the present disclosure may be made of nonferrous metal so as to maintain strength at a desired level and reduce weight in comparison with steel. Particularly, the swivel upper plate module 42 may be made of any nonferrous metal among aluminum alloys or zinc alloys.

The swivel upper plate module 42 may be made of a material different from aluminum alloys or zinc alloys as long as the swivel upper plate module 42 may ensure strength at a level of steel and reduce weight in comparison with steel.

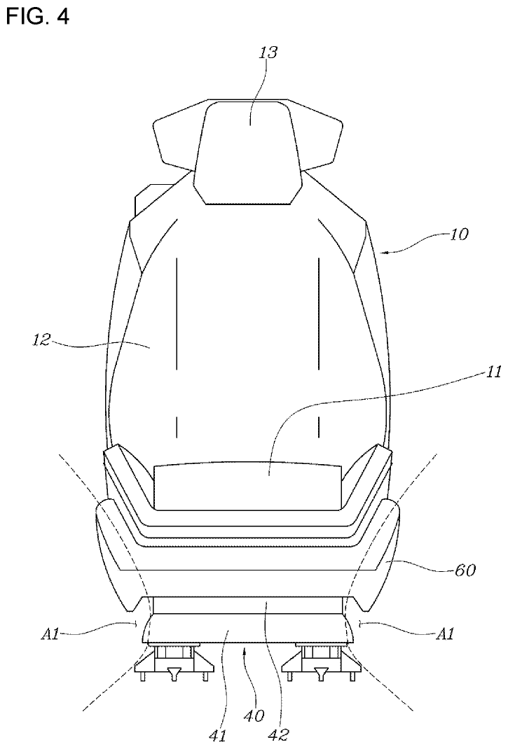

In the embodiment according to the present disclosure, the modularized structure in which the set bracket parts 423 are integrated with the swivel upper plate module 42 is implemented. Therefore, as illustrated in FIG. 4, the left and right sides of the swivel upper plate module 42 may be positioned inward from the left and right sides of the seat bracket 60 coupled to the seat 10 to cover a lower side of the seat 10. Therefore, the design of the lower side of the seat 10 may be slim, and the left and right spaces A1 of the slim lower side of the seat 10 may ensure foot spaces for the passengers seated in the rear seats, thereby improving ride quality of the passengers.

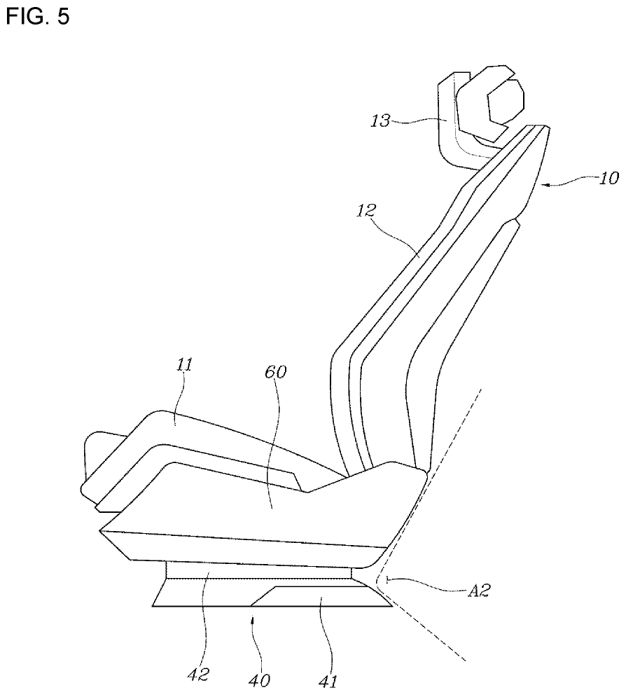

In addition, in the embodiment according to the present disclosure, the modularization structure in which the set bracket parts 423 are integrated with the swivel upper plate module 42 is implemented. Therefore, as illustrated in FIG. 5, the rear side of the swivel upper plate module 42 may be positioned inward from the rear side of the seat bracket 60 coupled to the seat 10 to cover the lower side of the seat 10. Therefore, the design of the lower side of the seat 10 may be slim, a rear space A2 of the slim lower side of the seat 10 may ensure a foot space for the passenger seated in the rear seat, thereby improving ride quality of the passenger.

As described above, the seat structure according to embodiments of the present disclosure may include the swivel upper plate module 42 in which the swivel upper plate part 421, the swivel reinforcing member part 422, and the set bracket parts 423 are modularized to be integrated, and the swivel upper plate module 42 may be coupled to the seat cushion frame 21. Therefore, it is possible to reduce the number of components, costs, and weight in comparison with the structure in the related art in which the swivel upper plate, the swivel reinforcing member, and the set bracket are configured as separate components.

In addition, in the seat structure according to embodiments of the present disclosure, the modularized structure in which the set bracket parts 423 may be integrated with the swivel upper plate module 42 is implemented. Therefore, the left and right sides of the swivel upper plate module 42 may be positioned inward from the left and right sides of the seat bracket 60 coupled to the seat 10 to cover a lower side of the seat 10. Therefore, the design of the lower side of the seat 10 may be slim, and the left and right spaces A1 of the slim lower side of the seat 10 may ensure foot spaces for the passengers seated in the rear seats, thereby improving ride quality of the passengers.

In addition, in the seat structure according to embodiments of the present disclosure, the modularization structure in which the set bracket parts 423 are integrated with the swivel upper plate module 42 is implemented. Therefore, the rear side of the swivel upper plate module 42 may be positioned inward from the rear side of the seat bracket 60 coupled to the seat 10 to cover the lower side of the seat 10. Therefore, the design of the lower side of the seat 10 may be slim, a rear space A2 of the slim lower side of the seat 10 may ensure a foot space for the passenger seated in the rear seat, thereby improving ride quality of the passenger.

While the specific embodiments of the present disclosure have been illustrated and described, it will be obvious to those skilled in the art that the present disclosure may be variously modified and changed without departing from the technical spirit of the present disclosure defined in the appended claims.

What is claimed is:

1. A seat structure for a vehicle, the seat structure comprising:
a) a swivel upper plate module comprising:
i) a swivel plate part, and
ii) a swivel reinforcing member part; and
iii) set bracket parts to which a rotary link is coupled to adjust a height of a seat are modularized to be integrated; and
b) a seat frame to which the swivel upper plate module is fixedly coupled.

2. The seat structure of claim 1, wherein the swivel upper plate part is fixedly coupled to a seat cushion frame.

3. The seat structure of claim 1, wherein the set bracket parts are configured to extend in a forward/rearward direction and are connected to left and right sides of the swivel upper plate part, and the swivel reinforcing member part is connected to a front surface of the swivel upper plate part and has two opposite left and right ends connected to the set bracket parts.

4. The seat structure of claim 3, wherein the swivel upper plate module further comprises a rear reinforcing part protruding upward from a rear surface of the swivel upper plate part.

5. The seat structure of claim 1, wherein the swivel upper plate module is made of nonferrous metal to reduce weight thereof.

6. The seat structure of claim 1, wherein the swivel upper plate module is made of any one nonferrous metal among aluminum alloys and zinc alloys to reduce weight thereof.

7. The seat structure of claim 1, wherein left and right sides of the swivel upper plate module are positioned inward from left and right sides of a seat bracket coupled to the seat to cover a lower side of the seat, such that a design of the lower side of the seat is slim, and left and right spaces at the slim lower side of the seat ensure foot spaces for passengers seated in rear seats.

8. The seat structure of claim 1, wherein a rear side of the swivel upper plate module is positioned inward from a rear side of a seat bracket coupled to the seat to cover a lower side of the seat, such that a design of the lower side of the seat is slim, and a rear space at the slim lower side of the seat ensures a foot space for a passenger seated in a rear seat.

9. A seat structure for a vehicle, the seat structure comprising:
a swivel upper plate module in which a swivel upper plate part configured to constitute a swivel device and set bracket parts to which a rotary link is coupled to adjust a height of a seat are modularized to be integrated; and
a seat frame to which the swivel upper plate module is fixedly coupled.

10. The seat structure of claim 9, wherein the swivel upper plate module further comprises a swivel reinforcing member part connected to a front surface of the swivel upper plate part and having two opposite left and right ends connected to the set bracket parts, the swivel upper plate module being configured to reinforce strength of the swivel upper plate part.

11. The seat structure of claim 10, wherein the swivel upper plate module further comprises a rear reinforcing part protruding upward from a rear surface of the swivel upper plate part.

12. A vehicle comprising a seat structure of claim 1.
